(19) United States
(12) Patent Application Publication
(10) Pub. No.: US 2021/0357013 A1
(43) Pub. Date: Nov. 18, 2021

(54) ADDITIONAL POWER SUPPLIES

(71) Applicant: Hewlett-Packard Development Company, L.P., Spring, TX (US)

(72) Inventors: Chao-Wen Cheng, Taipei City (TW); Tsung Yen Chen, Taipei City (TW); Mo-Hsuan Lin, Taipei City (TW); Roger A. Pearson, Fort Collins, CO (US); Po-Ying Chih, Taipei City (TW); Chien Fa Huang, Taipei City (TW)

(73) Assignee: Hewlett-Packard Development Company, L.P., Spring, TX (US)

(21) Appl. No.: 17/043,087

(22) PCT Filed: Oct. 10, 2018
(86) PCT No.: PCT/US2018/055185

§ 371 Date: Sep. 29, 2020

(51) Int. Cl. G06F 1/26; G06F 13/40; G06F 13/42

(52) U.S. Cl. CPC G06F 1/266; G06F 1/263; G06F 2213/0042; G06F 13/4282; G06F 13/4068

(57) ABSTRACT

Examples described herein relate to a non-transitory machine-readable medium consistent with the disclosure. For instance, the non-transitory machine-readable medium may store instruction executable by a processing resource to transfer additional power through a power delivery cable, input the additional power to a component of a computing device, and sequence the additional power with a main power supply of the computing device.

### BACKGROUND

A computing device may include a plurality of universal serial bus (USB) ports for connection, communication, and power supply between the computing device and electronic devices. Electronic devices coupled to the computing device via a USB port may transmit information to and from the computing device and/or may share a power supply with the computing device and therefore impact the power usage of the computing device.

### BRIEF DESCRIPTION OF THE DRAWINGS

FIG. 1 illustrates an example of an apparatus suitable with a system consistent with the disclosure,

FIG. 2 illustrates an example of a system consistent with the disclosure.

FIG. 3 illustrates an example of a computing device consistent with the disclosure.

FIG. 4 illustrates an example diagram of a non-transitory machine readable medium suitable with a system consistent with the disclosure.

FIG. 5 illustrates an example of a component suitable with a system consistent with the disclosure.

### DETAILED DESCRIPTION

Computing devices may include components such as, graphic processing units, central processing units, and/or motherboards. The computing device may include a main power supply to provide power to the computing device. The power supply may also provide power to the components in the computing device. As used herein, “computing device” refers to a device including a processor, memory, and input/output interfaces for wired and/or wireless communication.

However, the components of the computing device may permit use of more power than supplied by the main power supply. That is, the components of the computing device may not perform as intended by the manufacturer when using an amount of power supplied by the main power supply. Moreover, some computing devices may not allow components of the computing devices to receive additional power directly from an additional power supply.

Accordingly, additional power supplies may transfer additional power through a power delivery cable, input the additional power to a component of a computing device, and sequence the additional power with a main power supply of the computing device, as described herein. As such, computing devices, as described herein, may include components of a computing device that receive additional power (in addition to a main power) through a power delivery cable and a device to sequence the additional power with the main power. Inputting additional power into the components of the computing device may allow the components to function as intended by the manufacturer when the main power supply does not supply enough power to the components of the computing device. Accordingly, this disclosure describes components that receive additional power through a power delivery cable.

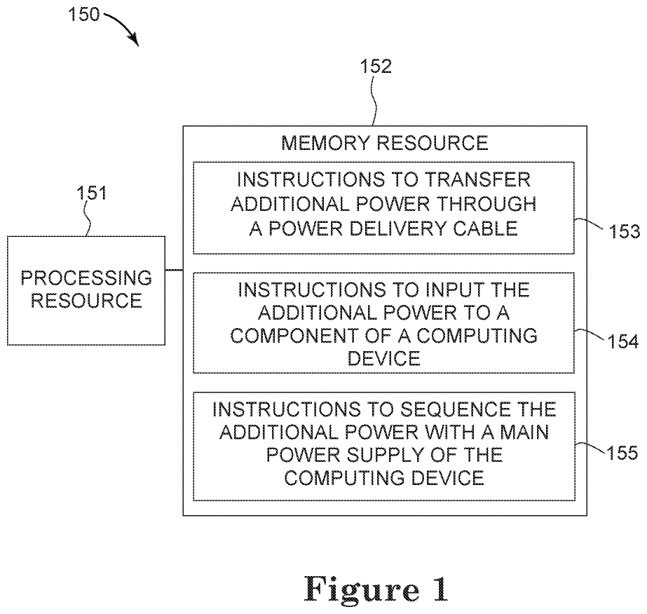

FIG. 1 illustrates an example of an apparatus 150 suitable with a system consistent with the disclosure. As illustrated in FIG. 1, the apparatus 150 includes a processing resource 151 and a memory resource 152. The processing resource 151 may be a hardware processing unit such as a microprocessor, application specific instruction set processor, coprocessor, network processor, or similar hardware circuitry that may cause machine-readable instructions to be executed. In some examples, the processing resource 151 may be a plurality of hardware processing units that may cause machine-readable instructions to be executed. The processing resource 151 may include central processing units (CPUs) among other types of processing units. The processing resource 151 may also include dedicated circuits and/or state machines, such as in an Application Specific Integrated Circuit (ASIC), Field Programmable Gate Array (FPGA) or similar design-specific hardware. The memory resource 152 may be any type of volatile or non-volatile memory or storage, such as random-access memory (RAM), flash memory, read-only memory (ROM), storage volumes, a hard disk, or a combination thereof.

The memory resource 152 may store instructions thereon, such as instructions 153, 154, and 155. When executed by the processing resource 151, the instructions may cause the apparatus 150 to perform specific tasks and/or functions. For example, the memory resource 152 may store instructions 153 which may be executed by the processing resource 151 to cause the apparatus 150 to transfer additional power through a power delivery cable. In some examples, the power delivery cable may be a USB power delivery (PD) cable. As used herein, “power delivery cable” refers to a cable that supplies power to a device. In some examples, different components of a computing device may use more power than the computing device is able to provide. As used herein, “component” refers to a part of a system and/or computing device, For example, the component may be a graphic processing unit, a central processing unit, a motherboard, etc. Additional power may be transferred into the components to provide the component with the power to function as intended by the manufacturer. For example, a component that does not receive enough power from a computing device and/or is not functioning as intended by the manufacturer may produce an incorrect graphical display, take a longer time to produce a graphical display (compared to components with substantial similar specification), cause the computing device to perform a forced shutdown, prevent a computing device from powering up and/or loading, cause the computing device to continuously freeze, cause a display screen to black out, amongst other possibilities. As used herein, the term substantially intends that the characteristic does not have to be absolute but is close enough so as to achieve the characteristic. For example, “substantially similar” is not limited to absolutely similar.

In some examples, additional power may be transferred through a power delivery cable from a power adaptor. However, this disclosure is not so limited. Additional power may be transferred through a power delivery cable from another power source, such as an internal power supply. In some examples, the power delivery cable may be a USB Type-C cable. In some examples, the USB Type-C cable may provide a constant power supply to a component of the computing device. As used herein, “additional power” refers to power from an additional power supply that is not supplied by the main power supply of the system and/or computing device.

The memory resource 152 may store instructions 154 which may be executed by the processing resource 151 to cause the apparatus 150 to input the additional power to a component of a computing device. The processing resource 151 may allow an external power device to supply power to a component of the computing device. That is, if a user updates a component of the computing device the updated component may user more power than the computing device is able to produce. The component may use additional power to function as intended by the manufacturer. A USB Type-C cable may be used to transfer power from an external power device into the component, In some examples, a power delivery cable may be used to transfer power from an internal power device into the component. The additional power supply may be an internal power supply added to the computing device. As used herein, “additional power supply” refers to a power supply that is not original to the system and/or computing device and/or a power supply that is not the main power supply, For example, an additional power supply may be an internal power supply, a power adaptor, a battery, etc.

The memory resource 152 may store instructions 155 which may be executed by the processing resource 151 to cause the apparatus 150 to sequence the additional power with a main power supply of the computing device. The main power supply of the computing device may conflict with the additional power supplied to the component of the computing device. As such, the computing device may include a power management device to sequence the additional power with the main power of the computing device. That is, the power management device may ensure that the voltage of the additional power matches the voltage of the main power. In addition, sequencing the additional power with the main power may cause the input of additional power to occur at the same time as the input of main power. This may prevent the additional power supply from providing power to the component when the component is not in use. As used herein, “power management device” refers to a device used to manage and/or coordinate the power inputted into the computing device. For example, the power management device may be a voltage regulator to stabilize, sequence, and/or match the power inputted into the computing device.

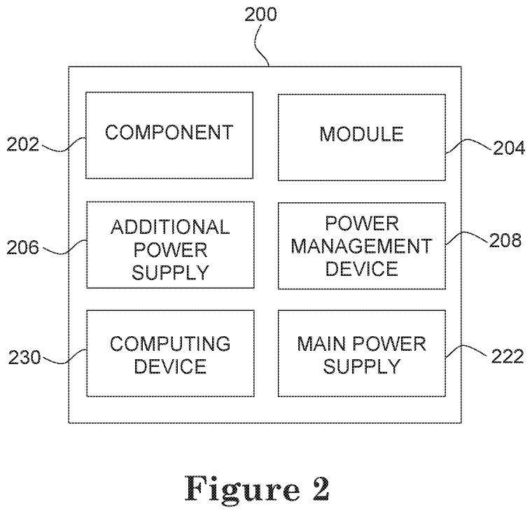

FIG. 2 illustrates an example of a system 200 consistent with the disclosure. The system 200 may be suitable with a variety of computing devices, such as laptops, desktops, etc., for example. In some examples, the system 200 may include a component 202 connected to a computing device 230. In some examples, the component 202 may be removable connected to the computing device 230. That is, the component 202 may be taken out of the computing device 230 and placed back in the computing device 230. In some examples, the component 202 may be a graphics processing unit (GPU) of the computing device 230. However, this disclosure is no so limited. In some examples, the component 202 may be a central processing unit (CPU). In some examples, the component 202 may be a motherboard of the computing device 230.

That is, the component 202 may be hardware in a computing device 230. It should be understood that when an element is referred to as being “on,” “connected to”, “coupled to”, or “coupled with” another element, it may be directly on, connected, or coupled with the other element or intervening elements may be present. In some examples, the component 202 may be an upgraded and use more power than originally estimated by the system 200. As used herein, “graphics processing unit” refers to a programmable logic chip specialized for display functions. As used herein, “central processing unit” refers to electronic circuitry within a computing device that carries out the instructions of a computer program. As used herein, “motherboard” refers to printed circuit board (PCB) found in general purpose microcomputers and other expandable systems.

In some examples, the component 202 may use additional power not supplied by the main power supply 222 of the computing device 230. That is, the components 202 may use more power than the main power supply 222 of the computing device 230 may provide to work as intended. For instance, the main power supply 222 of the computing device 230 may provide the computing device with 300 watts of power. However, a component (e.g., a CPU) may consume more power than originally estimated by the system 200. As such, more power may be supplied to the computing device 230 to support the component 202. That is, an additional power supply may provide the computing device 230 with an additional 100 watts of power giving the computing device a total of 400 watts of power. In some examples, the additional power from the additional power supply may allow the component 202 to operate as intended by the manufacturer.

In some examples, the component 202 of the computing device 230 may be coupled to a module 204. As used herein, “module” refers to an electronic device able to be connected to a graphic processing unit, a central processing unit, and/or a motherboard that connects to and is used with a computing device, power supply, and/or electronic device. For example, the module 204 may be a power dongle connected to a graphics processing unit. In some examples, the module 204 may be a flex port connected to a motherboard. In some examples, the module 204 may connect a power delivery cable to the component 202. For example, the module 204 may allow a USB Type-C cable to connect to a component 202 to deliver additional power. The module 204 may connect to the component 202 to allow the component 202 to connect to the additional power supply.

In some examples, the component 202 may receive power from an additional power supply 206. The additional power supply 206 may be external to the computing device 230. For example, the additional power supply 206 may be an external power adaptor. In some examples, the additional power supply 206 may connect to a power delivery cable. For instance, the additional power supply 206 may use a USB PD cable to transfer additional power to the component 202. In some examples, the USB PD cable may be a USB Type-C cable. For example, the additional power supply 206 may transfer power through a USB Type-C cable into a motherboard (e.g., component 202) to supply the motherboard with additional power.

In some examples, the additional power supply 206 may supply additional power to a plurality of components 202. For example, the additional power supply 206 may supply power to a motherboard and a graphics processing unit. In some examples, the additional power supply 206 may connect to a plurality of power delivery cables to supply a plurality of components 202 with additional power at the same time. For instance, the additional power supply 206 may connect to a graphics processing unit and a central processing unit of the computing device 230 with separate USB Type-C cables and supply additional power to both the graphics processing unit and the central processing unit at the same time.

In some examples, the system 200 may include a power management device 208. The power management device 208 may coordinate the additional power supply with the main power supply 222 of the computing device 230. That is, the additional power supply 206 may continuously supply power to the system 200 even when the computing device 230 is not in use or receiving power from the main power supply 222. The power management device 208 may ensure that the components 202 of the computing device 230 do not receive additional power when the computing device 230 is not in use or receiving power from the main power supply 222.

That is, the power management device 208 may sequence the additional power transferred into the component 202 with the main power supply 222 of the computing device 203. The input of power from the additional power supply may occur at the same time as the input of power for the main power supply 222. In some examples, the input of power for the additional power rises and falls as the input of power for the main power supply 222 of the computing device 230 rises and falls, The power management device 208 may allow the main power supply 222 and the adaptor to coordinate the input of power into the system 200. In addition, the power management device 208 may convert the voltage of the power received from the additional power supply to match the voltage from the main power supply 222 of the computing device 230.

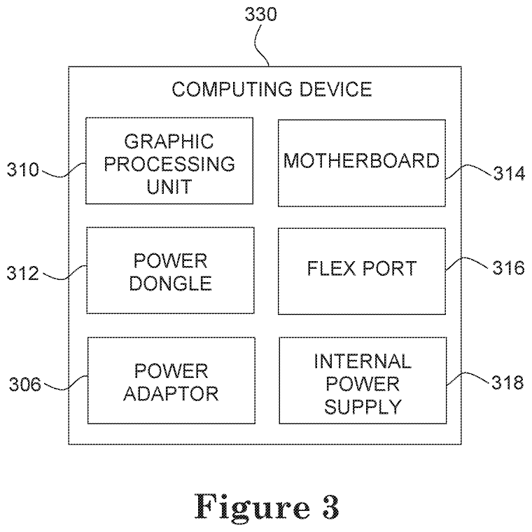

FIG. 3 illustrates an example of a computing device 330 consistent with the disclosure. Computing device 330 is analogous or similar to computing device 230 of FIG. 2. In some examples, the computing device 330 may include a component. In some examples, the computing device 330 may include a plurality of components. For example, a component of the computing device 330 may be a graphic processing unit 310. In addition, a component of the computing device 330 may be a motherboard 314. In some examples, the component of the computing device 330 may be a central processing unit.

In some examples, the graphic processing unit 310 may use an additional power supply to perform as intended by the manufacturer. For example, the additional power supply may be a power adaptor 306. That is, the graphic processing unit 310 may receive additional power from an external power adaptor 306 to perform as intended. The power adaptor 306 may supply additional power to the graphic processing unit 310. In some examples, the power adaptor 306 may transfer additional power into a graphic processing unit 310 with a USB Type-C cable. The USB Type-C cable may connect to a power dongle 312 coupled to the graphic processing unit 310. The power dongle 312 may allow for USB Type-C cable to connect to the graphic processing unit 310.

In some examples, the motherboard 314 may use an additional power supply. For example, the additional power supply may be an internal power supply 318. For instance, the motherboard 314 may receive additional power from an internal power supply 318. In some examples, the internal power supply 318 may transfer additional power into a motherboard 314 unit with a USB Type-C cable.

The USB Type-C cable may connect to a flex port 316 coupled to the motherboard 314. The flex port 316 may allow for USB Type-C cable to connect to the motherboard 314. In some examples, the flex port 316 is a removable flex port, That is, the flex port 316 may be removed from the motherboard 314 when the motherboard 314 is not using additional power. Likewise, the flex port 316 may be added to the motherboard 314 when the motherboard 314 is using additional power.

In some examples, the internal power supply 318 may supply additional power to a plurality of components (e.g., motherboard 314, graphic processing unit 310, and/or central processing unit). For example, the internal power supply 318 may supply power to a motherboard 314 and a graphic processing unit 310. In some examples, the internal power supply 318 may connect to a plurality of power delivery cables to supply a plurality of components with additional power at the same time. For instance, the internal power supply 318 may connect to a graphic processing unit and a central processing unit of the computing device 330 with separate USB Type-C cables and supply additional power to both the graphic processing unit and the central processing unit at the same time. Similarly, the power adaptor 306 may supply additional power to a plurality of components (e.g., motherboard 314, graphic processing unit 310, and/or central processing unit). In some examples, the computing device 330 may include a plurality of additional power supplies (e.g., power adaptor 306 and internal power supply 318).

In some examples, the central processing unit may use additional power supplied from an additional power supply to function as intended by the manufacturer. For example, the central processing unit may receive additional power from an external power adaptor 306 or an internal power supply 318. In some examples, the additional power supply may transfer additional power into a central processing unit with a USB Type-C cable. The USB Type-C cable may connect to a power dongle 312 coupled to the central processing unit. The power dongle 312 may allow for USB Type-C cable to connect to the central processing unit.

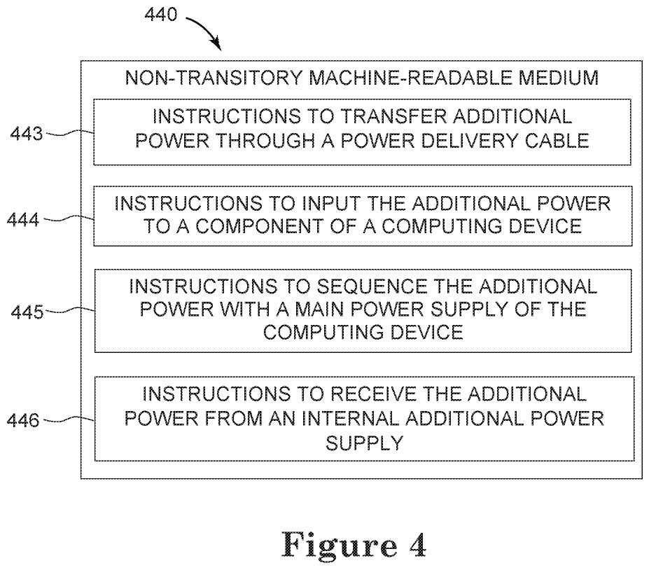

FIG. 4 illustrates an example diagram of a non-transitory machine readable medium 440 suitable with a system consistent with the disclosure. The non-transitory machine-readable medium 440 may be any type of volatile or non-volatile memory or storage, such as random-access memory (RAM), flash memory, read-only memory (ROM), storage volumes, a hard disk, or a combination thereof.

The medium 440 stores instructions 443 executable by a processing resource to transfer additional power through a power delivery cable. In some examples, the system may include updated components that use more power than the system provides. Power may be supplied to the updated component through a USB PD cable. In some examples, the USB PD cable may be a USB Type-C cable. In some examples, the USB Type-C cable may transfer additional power into the system to allow an updated component to receive enough power to work and perform as intended by the manufacturer. That is, additional power may be transferred into the updated components to provide the updated component with the power to perform as intended by the manufacturer. In some examples, the updated component may be a graphic processing unit, a central processing unit, a motherboard, etc. However, this disclosure is not so limited. In some examples, additional power may be transferred into a component in the system that uses more power than provided by the main power supply.

The medium 440 stores instructions 444 executable by a processing resource to input the additional power to a component of a computing device. In some examples, the component may receive additional power from an additional power supply added to the system. In various examples, the component of the computing device may receive additional power from a power adapter. In some examples, the component may receive power from a power outlet via a USB Type-C cable. The additional power may ensure that the component has enough power to perform as intended.

The medium 440 stores instructions 445 executable by a processing resource to sequence the additional power with a main power supply of the computing device. In some examples, the main power of a computing device may not supply enough power to the system to allow a component of the computing device to function as intended by the manufacturer. Additional power may be supplied to the component of the computing device to ensure that the component functions as intended by the manufacturer. In some examples, a power management device may be used to ensure that the additional power is inputted into the system at the same time as the main power. That is, if the computing device is powered on and in use the additional power supply is supplying power to the component. In contrast, if the computing device is not powered on or receiving power from the main power supply the component may not receive power from the additional power supply.

The medium 440 stores instructions 446 executable by a processing resource to receive the additional power from an internal additional power supply. In some examples, an additional power supply may be added to a computing device to supply additional power to a component in the system. In some examples, the additional power supply may transfer power into the component with a power delivery cable. In some examples, the power delivery cable may be a USB Type-C cable. However, this disclosure is not so limited. In some examples, the power delivery cable may be a USB 2.0 cable, USB 3.0 cable, etc.

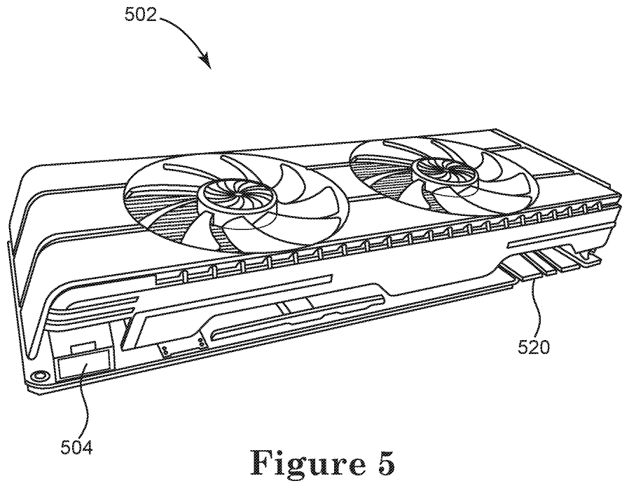

FIG. 5 illustrates an example of a component 502 suitable with a system consistent with the disclosure. Component 502 is analogous or similar to component 202 of FIG. 2. Module 504 is analogous or similar to module 204 of FIG. 2.

In some examples, the component 502 may be suitable with a variety of computing devices, such as laptops, desktops, etc., for example. In some examples, the component 502 may be an upgraded component that is not original to the computing device (e.g., computing device 330 of FIG. 3). That is, the component 502 may connect to the computing device through interface 520. The interface 520 may be a wired connection that connects the component 502 to the computing device. For example, interface 520 may be a Peripheral Component Interconnect (PCI), Direct Media Interface (DMI), etc. In some examples, the component 502 may consume more power than the original component to the computing device. As such, the component 502 may be supplied additional power from additional power supply. In some examples, the component 502 may receive additional power from a power adaptor (e.g., power adaptor 306 of FIG. 3). However, this disclosure is not so limited. In some examples, the component 502 may receive additional power from an internal power supply (e.g., internal power supply 318 of FIG. 3).

In some examples, the component 502 may include a module 504 to connect to the additional power supply. In some examples, the module 504 may be a flex port or a power dongle. The module 504 may be coupled to the component 502 and connect to a power delivery cable. The power delivery cable may transfer additional power from the additional power supply into the component 502. In some examples, the power delivery cable may be a USB Type-C cable.

In some examples, the component 502 may be a graphics processing unit (e.g., graphics processing unit 310 of FIG. 3) coupled to a power dongle (e.g. module 504). The power dongle may connect the graphics processing unit to a USB Type-C cable to act as a video graphics array for the computing device.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

It should be understood that the descriptions of various examples may not be drawn to scale and thus, the descriptions may have a different size and/or configuration other than as shown therein.

What is claimed:

1. A non-transitory machine-readable medium storing instructions executable by a processing resource to:
transfer additional power through a power delivery cable;
input the additional power to a component of a computing device; and
sequence the additional power with a main power supply of the computing device.

2. The non-transitory machine-readable medium of claim 1, wherein the component of the computing device is a graphics processing unit (CPU), central processing unit (CPU), or combinations thereof.

3. The non-transitory machine-readable medium of claim 2, wherein the component includes a power dongle to receive the additional power.

4. The non-transitory machine-readable medium of claim 1, wherein the power delivery cable is a USB Type-C cable.

5. The non-transitory machine-readable medium of claim 1, wherein the component of the computing device is a motherboard.

6. The non-transitory machine-readable medium of claim 1, wherein a power adaptor is to supply additional power to the power delivery cable.

7. The non-transitory machine-readable medium of claim 1, further including instructions to receive the additional power from an internal additional power supply.

8. A system comprising:
a module coupled to a component in a computing device to connect to a USB Type-C cable and receive additional power through the USB Type-C cable;
a power adaptor to supply additional power to the USB Type-C cable; and
a power management device to sequence the additional power to a main power supply of the computing device.

9. The system of claim 8, further comprising an additional power supply positioned in an expansion slot of the computing device to receive power from the power adaptor and deliver power to the module through the USB Type-C cable.

10. The system of claim 9, wherein the voltage of the additional power supply matches the voltage of the main power supply.

11. The system of claim 8, wherein the module is a power dongle embedded in a graphics processing unit (GPU) to receive additional power and output a video signal through the USB Type-C cable.

12. The system of claim 8, wherein the module is a removable flex port connected to a motherboard to receive additional power through the USB Type-C cable.

13. A computing device comprising:
a power dongle coupled to a graphics processing unit (GPU) of a computing device to connect to a USB Type-C cable and provide additional power to the graphics processing unit;
a removable flex port coupled to a motherboard of the computing device to provide additional power to the motherboard;
an internal power supply to supply additional power to the removable flex port, wherein the internal power supply is internal to the computing device; and
an external power adaptor to supply additional power to the power dongle.

14. The computing device of claim 13, further including a power management device to sequence the supply of additional power to a main power of the computing device.

15. The computing device of claim 14, wherein the power management device sequences the additional power with the main power by matching the input of addition power to the input of main power.
